(19) United States
(12) Patent Application Publication
(10) Pub. No.: US 2008/0065548 A1
(43) Pub. Date: Mar. 13, 2008

(54) Method of Providing Conditional Access

(75) Inventor: Marinus Carolus Mathijs Muijen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,910

(22) PCT Filed: Sep. 8, 2005
(86) PCT No.: PCT/IB05/52925

§ 371 Date: Mar. 8, 2007

(30) Foreign Application Priority Data
Sep. 10, 2004 (EP) 04104389.4

(51) Int. Cl. G06Q 10/00; H04L 9/32

(52) U.S. Cl. 705/51; 705/1

(57) ABSTRACT

There is described a communication system (10; 300; 2400; 2700) comprising a data content transmitter and at least one data receiver (50; 500; 2600). The system (10; 300; 2400; 2700) executes a method of associating data content with rights objects. The method comprises steps of (a) providing data content, rights objects defining rights to the content, and control messages for controlling subsequent processing of the content; (b) generating textual identifiers which are operable to associate said content with said rights objects; (c) transforming the textual identifiers into corresponding identification numerical data, said numerical data being more compact than their corresponding textual identifiers; and (d) compiling the numerical data, the rights objects and the messages into output for transmission and subsequent receipt at the at least one data receiver (50; 500; 2600). Transforming the textual identifiers potentially results in less data to be communicated and hence a reduced bandwidth requirement. The method is relevant, for example, to digital video broadcast (DVB).

The present invention relates to methods of providing conditional access to encrypted data streams using a stream-receiving device. Moreover, the invention also relates to communication systems, terminals and software configured to implement the methods. Furthermore, the invention relates to methods of associating data content with rights objects. Additionally, the invention relates to data streams generated pursuant to the aforesaid methods.

Communication systems operable to convey data content are well known. It has contemporarily become important within such communication systems to be able to control how data content is used and distributed, namely to provide a rights functionality associated with the distribution of data content. Inclusion of rights functionality within contemporary communication systems has been a topic of concern for many organizations attempting to achieve standardization, for example as in Open Mobile Alliance (OMA) and Digital Video Broadcast (DVB). DVB comprises a DVB Technical Module denoted by DVBTM-CBMS (Convergence of Broadcast and Mobile Services).

Data transmissions systems providing entitlement control messages (ECM) are known. For example, in a U.S. Pat. No. 6,668,320, there is described a transmission system including a receiver or set-top box which is capable of efficiently handling decryption of data packets. The system further includes a transmitter for transferring decryption keys to the receiver or set-top box, the decryption keys being necessary for decrypting encrypted data packets received at the receiver or set-top box. The decryption keys are in the form of entitlement control messages (ECMs). By decrypting an ECM at the receiver or set-top box, for example by employing a smart card which is included in the receiver or set-top box, the decryption key is revealed if the receiver or set-top box holds rights to a corresponding data service or entitlement. The transmission system described can be implemented to conform to digital video broadcasting (DVB) standards, for example as elucidated in a document Draft EN 301 192 v. 1.1.1, European Standard or DVB: IP Datacast Baseline Specification, DVB Document A080, April 2004.

The aforementioned DVB Specification for Data Broadcasting, for example as defined in ETSI TS 301 192, describes a method of securely broadcasting digital video content. The method involves distributing data content over a broadcast channel to a terminal such that no return channel is required. The data content is protected with three layers of encryption that reference each other. In a first layer, the data content is protected by encryption with a control word that changes over time. A given actual control word pertaining to a portion of the data content is distributed by broadcasting an entitlement control message (ECM), which is in turn distributed and encrypted in a second layer. A third layer is operable to distribute and encrypt keys for the entitlement control message (ECM). Since referencing between the layers is not contemporarily standardized, there are several proprietary solutions for providing such referencing presently in use. Such lack of standardization represents a technical problem when a stream-receiving device needs to support several proprietary solutions; the problem is encountered, for example, with handheld devices as specified in the DVB-H standard.

When OMA DRM 2.0 and DVB 1.0 are paired, the OMA DRM 2.0 rights objects that are associated with data content in the OMA DRM 2.0 system, and that establish usage rights for that data content in the OMA DRM 2.0 system, will need to be paired with the DVB 1.0 system. The present invention sets out to provide a solution to this particular and similar problems.

It is an object of the invention to provide a method of associating data content with rights objects that is efficient in its use of data in associating the data content to the rights objects.

The method is capable of being of benefit when a stream-receiving device only needs to support a single non-proprietary solution of providing referencing between aforementioned layers.

According to a first aspect of the invention, there is provided a method of associating data content with rights objects in a communication system, said system comprising a data content transmitter and at least one data content receiver, said method comprising steps of:

(a) providing data content, rights objects defining rights to the data content, and control messages for controlling subsequent processing to be applied to the data content, wherein said control messages associated with said data content reference said rights objects;

(b) generating textual identifiers operable to associate said data content with said rights objects;

(c) transforming said textual identifiers into corresponding identification data; and

(d) compiling the identification data, the rights objects and the control messages to generate output data for transmission from the transmitter and subsequent receipt at said at least one data receiver.

The invention is of advantage in that the method of associating data content with rights objects is efficient in its use of data in associating the data content to the rights objects.

Optionally, in the method, said step of transforming said textual identifiers into said corresponding identification data involves transforming said textual identifiers into said corresponding identification data in binary form, said identification data in binary form being more compact than their corresponding textual identifiers. The method is of benefit in that transformation of textual identifiers into corresponding identification numerical data is capable of reducing bandwidth requirements within a communication system.

Optionally, in the method, the rights objects are OMA DRM rights objects. Such use of rights objects enables the invention to be used with contemporary data communication systems and networks.

Optionally, the method includes further steps of:

(e) receiving the output data at said at least one data receiver; and

(f) processing the identification data and regenerating therefrom an association between the data content and the rights objects for controlling use of the data content at said at least one data receiver.

The at least one data receiver is thereby capable of receiving the identification numerical data and therefrom regenerating the association between the data content and the rights objects.

Optionally, in the method, the identification data is incorporated into the control messages when being compiled to generate the output data. Including the numerical data into the control messages allows for compact data for transmission from the transmitter and also enables straightforward regeneration of the association between the data content and the rights objects at the at least one receiver.

Optionally, in the method, the identification data is generated from the textual identifiers by way of one or more of: a hash function, an encryption function. Such a hash function or encryption function are potentially efficient for providing data compression as well as maintaining secrecy to third parties attempting to eavesdrop or otherwise gain unauthorized access to the data content.

More optionally, in the method, the hash function is substantially implemented by way of a contemporary Message Digest pursuant to contemporary standard RFC 1320/1321 such as MD4 or MD5. Alternatively, or additionally, the hash function is substantially implemented by way of a SHA-1 Secure Hash Algorithm pursuant to contemporary standard FIPS 180-2. Alternatively, or additionally, the encryption function is implemented substantially pursuant to contemporary advanced encryption standard FIPS 197 utilizing a public symmetrical key for the transmitter and said at least one data receiver. Such hash functions and encryption are contemporarily employed in data communication systems compliant to various standards, thereby rendering the method of the invention beneficially more readily applicable in such contemporary data communication systems.

Optionally, to beneficially implement distribution of access rights to various users at said at least one data receiver, the method is implemented such that a plurality of said data receivers are initially registered to the system by the method including additional steps of:

(g) grouping the plurality of data receivers into a broadcast domain; and

(h) communicating one or more access keys to the plurality of broadcast receivers in the broadcast domain for defining data content accessible to the broadcast domain, said keys being useable to access encrypted rights objects communicated in the system.

Optionally, in the method, the data content is associated by the textual identifiers with its associated rights objects by way of a uniform resource indicator comprising a content identifier linked to a corresponding universal resource locator. Such an approach renders the method compatible with Internet protocol (IP) and therefore easier to implement in contemporary data communication systems employing such protocol.

Optionally, in the method, regenerating the association between the data content and the rights objects at each data receiver involves deriving from the control messages a universal resource indicator <uid> and therefrom a content indication <binary_content_id> for use in searching corresponding rights objects, such that a lack of a match found at the data receiver between the content indication and rights objects stored in the data receiver, or externally accessible to the data receiver, is indicative of the data receiver lacking rights to access the data content.

According to a second aspect of the present invention, there is provided a method of providing conditional access, said method comprising steps of:

Including encrypted data content in a data stream, wherein decryption of said data content requires temporally changing control words;

Including first decryption control messages in the data stream, each first decryption control message containing at least one of control words required for decrypting data content that is substantially contemporaneous with the first decryption control message in the data stream;

Extracting a first decryption control message from the data stream in a stream receiving device;

Associating an OMA DRM rights object to the first decryption control message extracted;

Obtaining a content encryption key from the OMA DRM rights object associated;

Decrypting the first decryption control message extracted using the content encryption key obtained from the OMA DRM rights object;

Extracting a control word from the first decryption message decrypted; and

Decrypting the encrypted data content using the control word extracted from the first decrypted message decrypted.

The invention is of advantage in that the method is capable of requiring a stream-receiving device only needing to support a single non-proprietary solution of providing referencing between aforementioned layers.

Optionally, in the method, the step of associating an OMA DRM rights object to the first decryption control message extracted further comprises steps of:

Mapping an address of the OMA DRM rights object to one or more bits;

Including said one or more bits in the first decryption control message;

Extracting said one or more bits from the first decryption control message received;

Comparing said one or more bits extracted with one or more bits of a stored OMA rights object; and

Selecting the stored OMA DRM rights object to be the OMA DRM rights object associated when said one or more bits extracted are equal to one or more bits of the stored OMA DRM rights object.

Mapping the address to a number of bits is capable of improving efficiency of the method, namely the one or more bits may be chosen to be smaller than the address. The one or more bits are therefore able to be accommodated into the first decryption control message.

Optionally, in an embodiment of the invention, the method is further distinguished in that the step of mapping an address of the OMA DRM rights object to one or more bits includes calculating a hash of the address of the OMA DRM rights object. Using a hash for the mapping reduces a risk that the one or more bits are reversely mapped onto the address, for example as may be attempted by an attacker.

More optionally, the step of calculating the hash of the address of the OMA DRM rights object further comprises selecting a hash function from a set of hash functions. Selecting a hash function out of a set of hash functions provides for an improved flexibility and security. Also, evaluating hash functions may be performed in dedicated hardware in a receiving device. Such dedicated hardware may be utilized without restricting the method to a single hash function. Yet more optionally, in the method, the hash function selected is indicated by a bit in the first decryption message. By indicating the selected hash function by a bit in the first decryption message, the selection for a single data stream may be altered over time, thereby further improving security.

Optionally, in the method, the address is a URI of the OMA DRM rights object. The URI of the OMA DRM rights object is a practical address, because it is capable of facilitating access to the OMA DRM rights object.

It will be appreciated that features of the invention are susceptible to being combined in any combination without departing from the scope of the invention as defined by the accompanying claims. The above object and features of the method of the present invention will be more apparent from the following description.

Embodiments of the invention will now be described, by way of example only, with reference to the following drawings wherein:

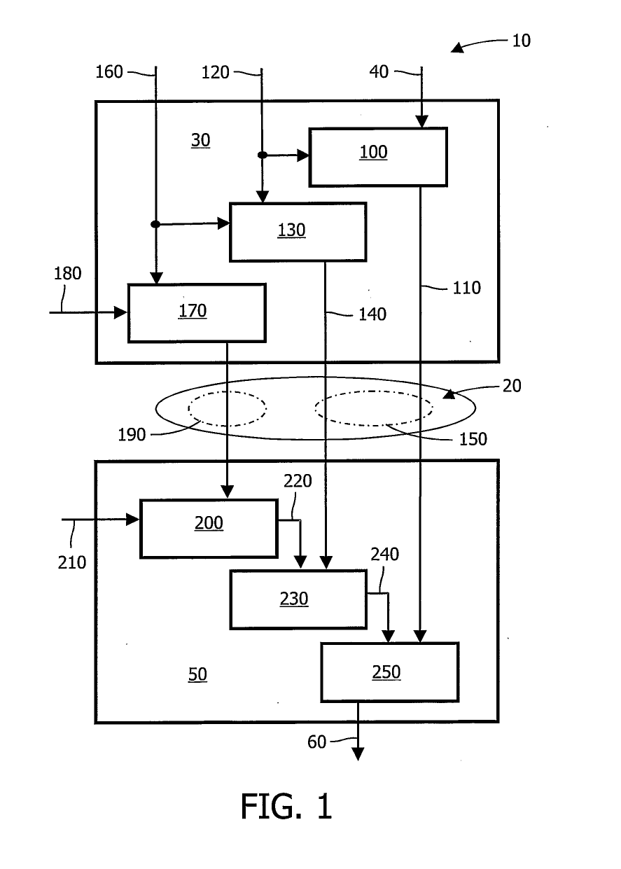

FIG. 1 is a schematic diagram of a communication system, for example in a context of digital video broadcast (DVB), operable to convey from a transmitter to a receiver encrypted data content together with entitlement control messages and rights objects (RO);

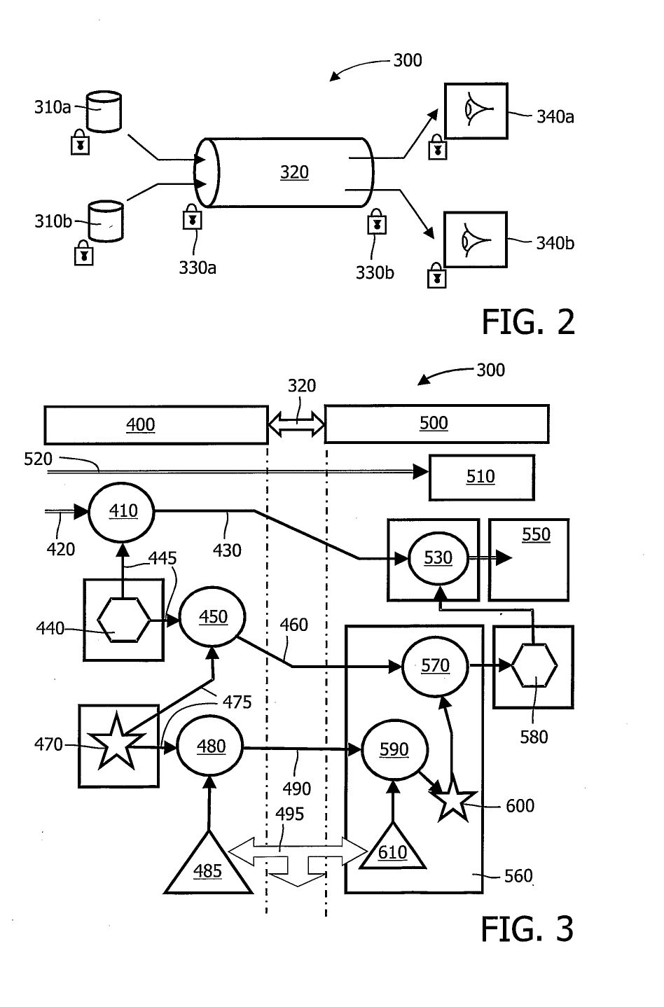

FIG. 2 is a schematic diagram of a communication system represented with regard to data content protection and service protection therein, the system being pursuant to the present invention;

FIG. 3 is a schematic diagram illustrating encryption and decryption layers provided in the communication system of FIG. 2;

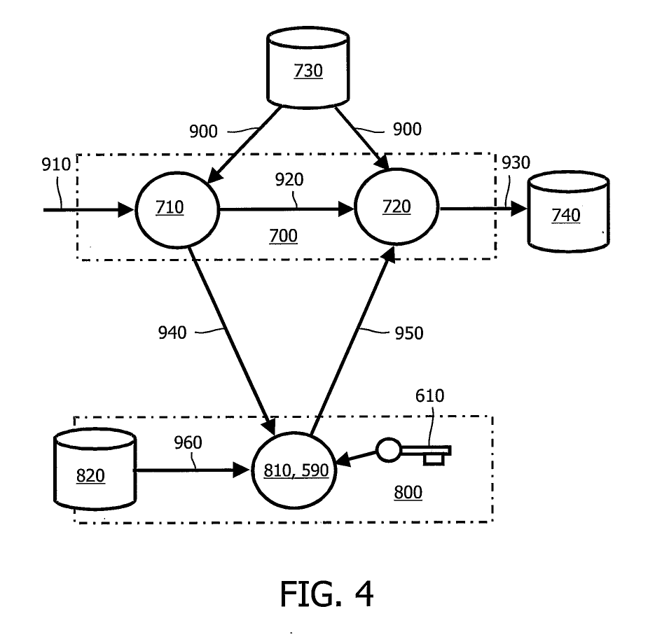

FIG. 4 is a schematic diagram of operational parts of a terminal portion of a system illustrated in FIG. 2;

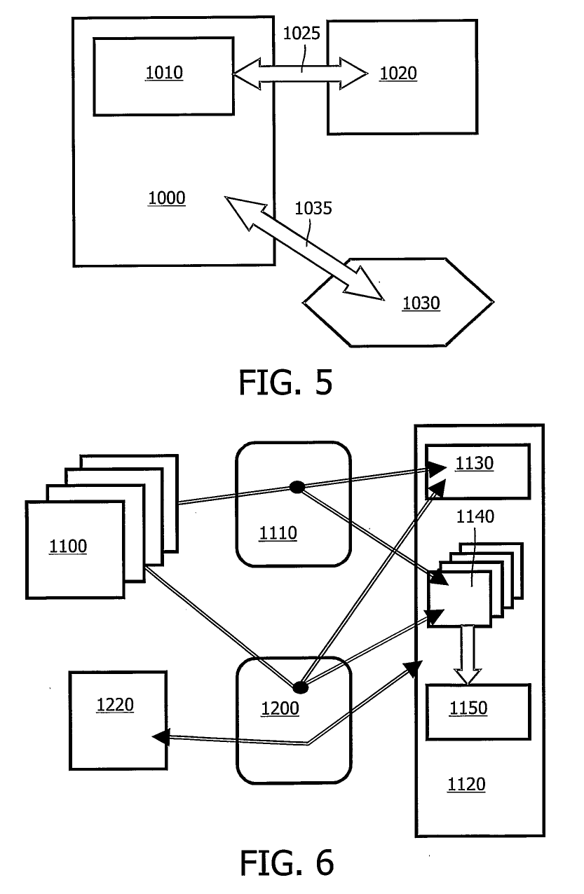

FIG. 5 is a schematic illustration of an interrelationship between rights objects with associated textual identifiers, encrypted data content and entitlement control messages;

FIG. 6 is a schematic diagram of data services provided within the system of FIG. 2;

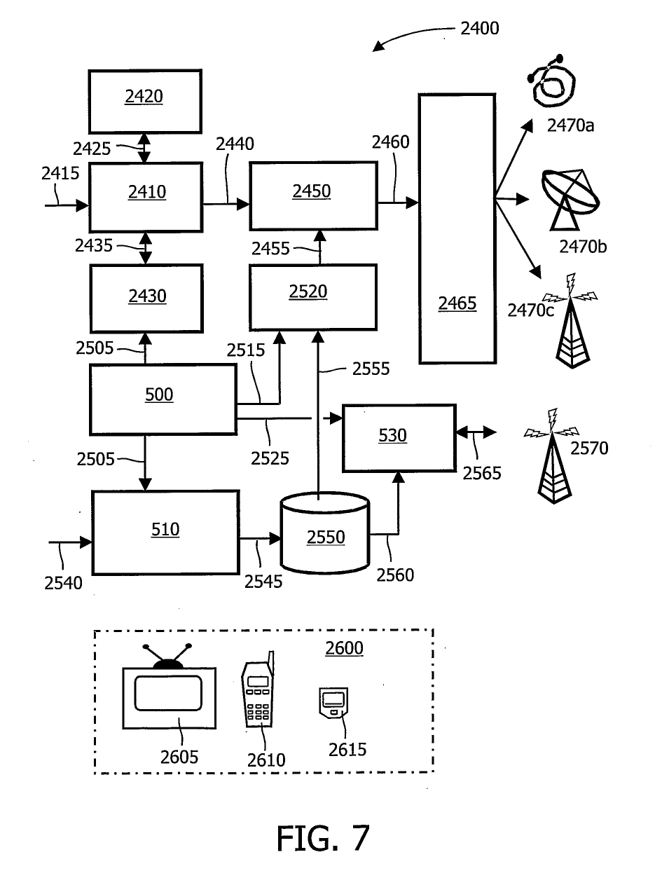

FIG. 7 is a schematic diagram of a first practical architecture of the communication system according to the present invention, the practical architecture being operable to associate encrypted data content with corresponding entitlement control messages (ECM) and rights objects (RO);

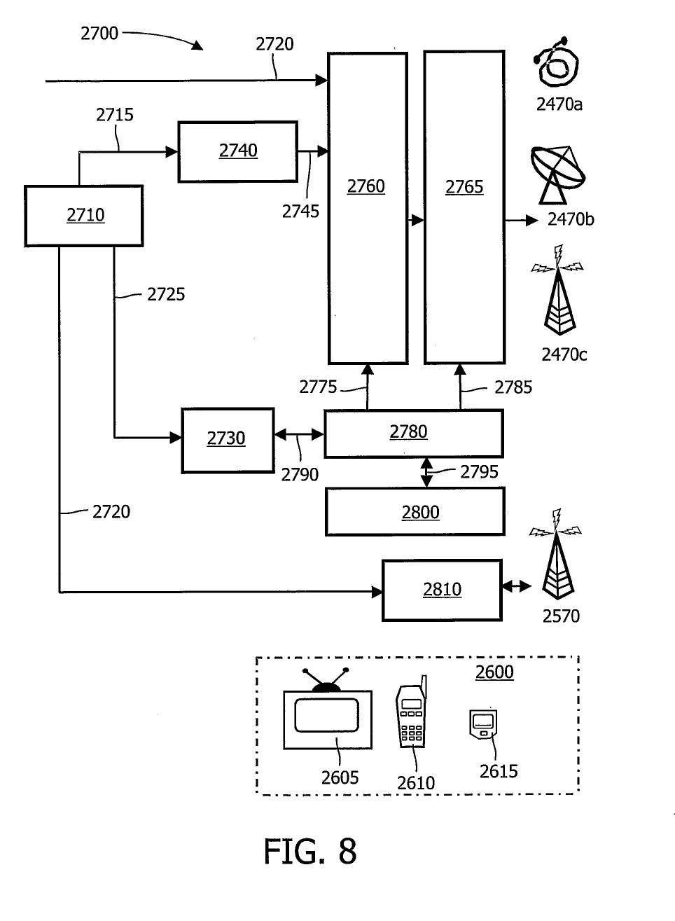

FIG. 8 is a schematic diagram of a second practical architecture of the communication system according to the present invention, the practical architecture being operable to function according to the present invention regarding a manner in which encrypted data content is associated with corresponding entitlement control messages (ECM) and rights objects (RO);

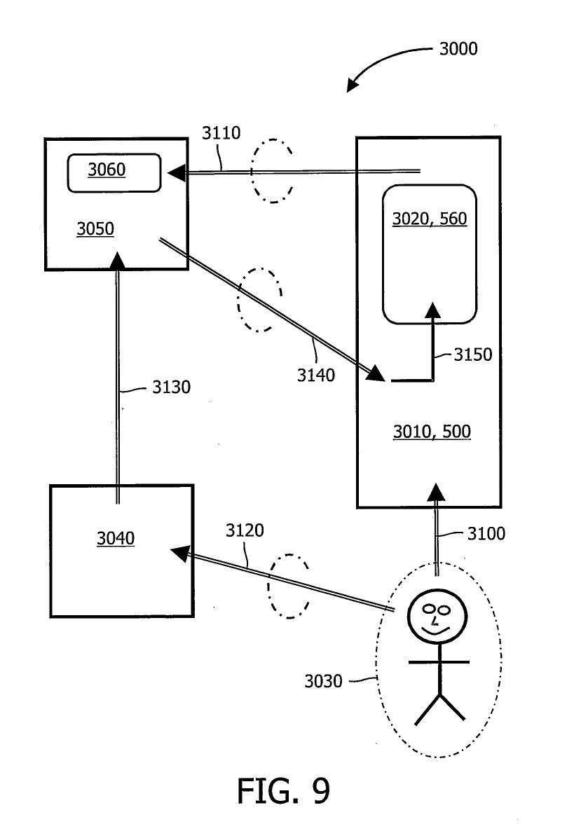

FIG. 9 depicts a process whereby a terminal is able to obtain protected data content when interaction is available, the process being pursuant to the present invention; and

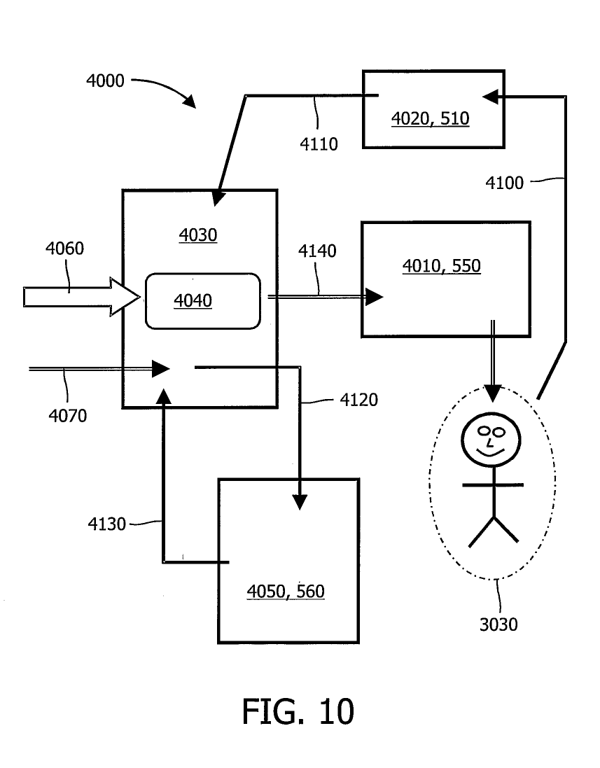

FIG. 10 depicts a process for obtaining protected data content when interaction is not available, the process being pursuant to the present invention.

In FIG. 1, there is illustrated a communication system indicated generally by 10 for transmitting data content over a broadcast channel indicated by 20. The system 10, for example, conforms to a contemporary DVB 1.0 standard. Moreover, the system 10 includes a transmitter 30 for encrypting data content 40 input thereto to generate corresponding encrypted output data for output to the broadcast channel 20, and a receiver 50 for receiving the encrypted output data received via the broadcast channel 20 and decrypting the output data to generate corresponding decrypted output data 60. The transmitter 30, for example, can belong to a data content provider, whereas the receiver 50 can, for example, belong to an end user or viewer. In overview, the system 10 is operable to protect data content conveyed via the broadcast channel 20 by way of encryption and also to provide a degree of control regarding how users are able to access and utilize the data content.

The transmitter 30 includes a first data processing unit 100 which is operable to receive the data content 40 and subject it to an IPsec/ESP encryption process to generate corresponding encrypted data 110. The encryption process is affected by control words 120 also provided to the transmitter 30. “IPsec” is an abbreviation for contemporary Secure Internet Protocol, and “ESP” is an abbreviation for contemporary Encapsulating Security Payload. Other content encryption methods can be optionally employed, for example secure RTP (Real-time Transport Protocol). RTP is a contemporary application level protocol that is intended for delivery of delay sensitive data content. The control words 120 are also conveyed to an ECM generation unit 130 for providing corresponding ECM data 140; as elucidated in the foregoing, “ECM” relates to Entitlement Control Management so the control words 120 are operable to control or dictate a manner in which the data content 40 is processed and subsequently supplied to the aforesaid viewer or user, for example for viewing. The encrypted data 110 and the ECM data 140 are collectively known as IP-DC (Internet Protocol Data Cast). The transmitter 30 is further provided with content encryption key data 160 which is conveyed to the ECM generation unit 130 for use therein and also to an OMA RO (Rights Object) issuing unit 170 which is also arranged to receive rights encryption key data 180 to generate corresponding IP output data 190. Such rights objects (RO), as will be elucidated in greater detail later, are a significant feature of the present invention and convey data regarding how the encrypted data content 110 when received at the receiver 50 is permitted to be used by the user or viewer, for example rights of access to and use of the data content 40. The IP-DC and IP data 190 are conveyed in operation to the receiver 50 whereat the encrypted data 110 is decrypted and the user provided appropriate access to the data content depending on additional data conveyed in the ECM data 140 and the IP output data 190.

The receiver 50 includes an OMA RO decoding unit 200 for receiving the IP data 190 and also the rights decryption key data 210, for example the decryption key data 210 being provided to the receiver 50 by way of a contemporary SIM card; “SIM” is an abbreviation for Subscriber Identity Module. Key material required for decrypting rights objects (RO) for OMA DRM, “DRM” being defined later, is provisioned during a registration phase using a 1-pass ROAP protocol, “ROAP” also being defined later. However, in substantially one-way broadcast environments, alternative approaches to ROAP are required, for example pre-registration using a SIM-chip. The OMA RO decoding unit 200 is operable to generate content decryption key data 220 which is conveyed from the decoding unit 200 to an ECM decoding unit 230 of the receiver 50. The ECM unit 230 is arranged to receive the ECM data 140 from the transmitter 30 as well as decryption key data 220 for generating corresponding control word data 240. The receiver 50 further includes IPSEC/ESP decryption unit 250 for receiving the control word data 240 from the ECM unit 230 as well as the encrypted data 110, the decryption unit 250 being operable to decrypt the encrypted data 110 in response to control parameters included within the control word data 240 to generate the decrypted output data 60 for use by the user or viewer.

In the system 10 depicted in FIG. 1, it will be appreciated that the transmitter 30 employs three stages of data processing, namely data content encryption, ECM data generation and rights issuing. The receiver 50 has three corresponding stages of data processing. For these three stages to function as intended so that the ECM data generation and rights issuing correctly reference to the data content, these three stages need to be correctly referenced to one another. For example, the encrypted data 110 is associated with the ECM data 140, and the ECM data 140 needs to correctly reference the IP data 190; IP data 190 includes, for example, rights objects (RO) which need to be appropriately referenced.

In the system 10, for example configured to conform to a contemporary OMA DRM 2.0 standard, rights objects (RO) present in the IP data 190 contemporarily employ textual identifiers to associated encrypted data content in the encrypted data 110 thereto. Thus, a further technical problem arises in OMA DRM 2.0 systems in that pairing OMA DRM 2.0 rights objects with corresponding DVB 1.0 ECM messages, the systems being configured for a broadcast only mode of operation, that data overhead of OMA aforementioned textual identifiers is inconveniently large; bandwidth allocated in such systems for conditional access and digital rights management in associated DVB-S/T/H environments is expensive to provide.

In the present invention, protection of IP-DC (Internet Protocol Data Cast) services is tackled on two different levels:

(a) on a content level, namely concerned with “content protection”; and

(b) on a service access level, namely concerned with “service protection” and to be distinguished from “conditional access” employed in conventional DVB CA (Digital Video Broadcast Conditional Access).

OMA DRM (Open Mobile Alliance Data Rights Management) is used for data content protection in contemporary communication systems. A current release of the OMA DRM standard, namely OMA DRM 2.0, supports distribution of data content in encrypted form and also ensures secure management and delivery of rights objects (RO) to users. A user's rights to data content can be expressed in a rights expression language, these rights being enforced by a DRM-enabled application at the user's terminal at a time of consumption of data content. Such an approach means that the protected data content is encrypted at all times. The OMA DRM 2.0 standard provides mechanisms and protocols which address all aspects of key management, including terminal registration and rights object (RO) delivery. Moreover, a domain concept employed in the OMA DRM 2.0 standard allows for multiple data content receiving devices, for example such multiple devices belonging to a same given user or group of users, to share rights objects (ROs).

For service protection, a combination of IPsec (Internet Protocol Security) and OMA DRM (Open Mobile Alliance Data Rights Management) is used. Such a combination provides an advantage that IPsec is defined by IETF (Internet Engineering Task Force) and represents an established framework for securing IP (Internet Protocol) data content flows; IPsec therefore supports all current state-of-the-art encryption algorithms, for example AES (Advanced Encryption Standard FIPS 197).

Beneficially, the use of IPsec (Internet Protocol Security) is capable of rendering service protection in the present invention substantially completely transparent for a given broadcast service application, for example on both network and terminal sides, thereby potentially any kind of service may be protected irrespective of specific protocols, whether standard or proprietary, used for the service.

Beneficially, use of OMA DRM ensures that mechanisms employed for secure key management and delivery are susceptible to being used for data content protection; for data content, the mechanisms are capable of providing for protection to be specifically defined for given items of data content, namely allowing for fine-grained rights expression.

OMA DRM and IPsec are leading open standards for content protection and IP security respectively. By employing OMA DRM in combination with IPsec to implement the present invention, utilization of the present invention in contemporary data content communication systems is possible, for example when implementing upgrades to the contemporary systems. Beneficially, many target devices of IP-DC (Internet Protocol Data Cast) services are anticipated to have both IPsec and OMA DRM implemented therein.

Beneficially, for such devices, the additional cost and complexity for supporting content and service protection as proposed here is potentially relatively low.

In implementing the present invention, the following issues however arise:

(a) a first issue of registration of devices and the delivery of rights objects (ROs) over the broadcast channel; and

(b) a second issue of key streams used to implement short-duration crypto periods with the longer-term validity of rights objects (ROs).

A distinction between content protection and service protection will now be elucidated. In FIG. 2, there is illustrated a communication system indicated generally by 300 pursuant to the present invention. The system 300 includes data providers 310a, 310b, a broadcast channel 320 provided with service protection at its sending and receiving ends 330a, 330b, and users 340a, 340b. The data providers 310a, 310b, as described later, can be included in a network, and the users 340a, 340b can be included as one or more terminals. In operation, data content with content protection is provided from the data providers 310a, 310b and is communicated with service protection through the broadcast channel 320 to the users 340a, 340b. The users 340a, 340b are able to apply data content protection measures to selectively gain access to the data content received thereat.

With regard to content protection in the system 300 depicted in FIG. 2, data content, for example streams of data or data files, is protected at a session or application layer within the system 300. Moreover, data content protection is managed and applied by a service operator, such data content protection being removed at data content consumption time at the users 340a, 340b. Beneficially, data content protection is potentially capable of providing aforementioned very fine-grained rights expression. Furthermore, data content protection provides for a separate mechanism of protection for each type of data content, for example to provide data content protection for a DRM-aware client or user application. In the present invention, for content protection, contemporary OMA DRM as elucidated in the foregoing is employed. Contemporary OMA DRM supports copy protection, a domain concept, and a subscription concept. The domain concept can, for example, be used for securing data content consumption in a small domain of terminals belonging to a same user. Additionally, the subscription concept can, for example, be used to implement content subscriptions.

With regard to service protection provided in connection with the broadcast channel 320, IP streams of data content are protected on a network layer. Moreover, the service protection is managed by a broadcast platform operator and applied by the broadcast network operator and removed at data content reception time. Moreover, when providing service protection, cryptographically secure access control, for example determining whether or not to allow access, can be combined with an aforementioned fine grained rights expression relying on tamper resistance. Furthermore, the service protection provides a single mechanism for all types of services, namely fully transparent for client applications.

In the context of the present invention, service protection is provided by combining IPsec, namely an established technology contemporarily used to encrypt IP data content streams, with OMA DRM, in particular building on its mechanisms for expression, acquisition and secure management of user rights. Several benefits derive from such an approach: IPsec (Internet Protocol Security) and OMA DRM (Open Mobile Alliance Data Rights Management) technologies are generic and are not limited to IPDC (Internet Protocol Data Cast) in particular, any existing implementations, namely hardware or software modules, of IPsec and OMA DRM can be used substantially without modifications to implement the present invention, namely they do not need to be IP-DC aware.

In FIG. 3, there is shown schematically encryption and decryption layers provided when implementing the present invention, for example in the system 300. A network of the system 300 is denoted by 400, and a user terminal denoted by 500; the system 300 can optionally include several such terminals. The broadcast channel 320 is operable to link the network 400 to the user terminal 500.

The network 400 includes an IPsec encryptor 410 for receiving video data content 420 and generating in operation a corresponding stream of encrypted IP multicast data 430. The network 400 further comprises an IPsec encryption key unit 440 for providing a traffic encryption key (TEK) 445 to the encryptor 410 and also to an encryptor 450 operable pursuant to OMA DRM standards. The encryptor 450 is operable to encrypt the traffic key (TEK) 445 to generate a corresponding encrypted TEK (Traffic Encryption Key) stream of data 460, such encryption using a service encryption key (SEK) 475 provided from a service encryption key unit 470, the service encryption key (SEK) defining DRM rights objects (ROs). The (SEK) key 475 is further provided to an encryptor 480 which is arranged in operation to receive the (SEK) key 475 and to encrypt and bundle the key 475 pursuant to OMA DRM standards employing a public or secret key 485 to generate a terminal-specific rights object (RO) key 490 in encrypted form. The public or secret key 485 is itself provided by way of device registration 495. Thus, the network 400 is operable to output the encrypted IP multicast data 430, the encrypted TEK (Traffic Encryption Key) stream of data 460 and the encrypted rights object key 490.

The user terminal 500 includes an ESG software application 510 executing on computing hardware for receiving protection relevant identifiers 520 from the network portion 400. In the user-terminal 500, there is further included an IPsec decryptor 530 operable to decrypt the encrypted IP multicast data 430 provided from the network portion 400 to generate decrypted video data content 540 for user consumption, for example at a media player 550. The user terminal 500 additionally includes a DRM module 560 including a decryptor 570 pursuant to the OMA DRM standard, the decryptor 570 being operable to receive the encrypted Traffic Encryption Key (TEK) stream of data 460 to generate a corresponding TEK decrypted key which is conveyed via a key module 580 to provide a decryption key for the decryptor 530 to use in decrypting the multicast data 430. Moreover, the DRM module 560 further includes a decryptor 590 pursuant to the OMA DRM standard operable to receive the encrypted rights object key 490 and to decrypt the rights object key 490 using a private or secret key 610 complementary to the public or secret key 485 to generate a SEK (Service Encryption Key) key 600 for use by the decryptor 570.

The DRM module 560 and the key module 580 need to be of trusted status in the user terminal 500, otherwise other items thereof can be potentially of untrusted status. Moreover, there is optionally provided one TEK per service to the user terminal 500. Moreover, the TEK is optionally frequently changed to enhance security, for example every few seconds. Optionally, the same SEK is repeatedly used. Beneficially, for example during a registration phase, the SEK is already delivered to the user terminal 500 and the network 400 before being used to encrypt TEKs; for example, one SEK can be provided per service per day. More beneficially, all SEKs of a service are bundled into one rights object.

The system 300 as represented by the network 400 and the user terminal 500 in FIG. 3 is conveniently understood by way of its layers 0 to 4. In the layer 0, signaling of the protection relevant identifiers 520 to the ESG application 510 occurs. The identifiers 520 include static protection parameters, namely valid over a whole lifetime of a given session. In the context of DVB CA (Digital Video Broadcast Conditional Access), communication of the protection relevant identifies 520 corresponds to contemporary CAT and EIT.

In the layer 1, IP (Internet Protocol) data content flows are encrypted by using the traffic encryption key (TEK) 445. In the system 300, multiple IP flows belonging to a given protected service are encrypted with a given key and transported on a given same time-slice through the broadcast channel 320. Thus, the IP multicast data 430 correspond to data output from a scrambled service with multiple components. In comparison to DVB CA, the TEK key 445 corresponds to a control word. Beneficially, the TEK key 445 is capable of being changed frequently, for example every few seconds.

In the layer 2, a traffic encryption key (TEK) stream is encrypted by using a service encryption key (SEK), namely the key 445 is encrypted at the encryptor 450 using the key 475 to generate the TEK stream of data 460. Encrypted TEK messages in the stream of data 460 are a separate IP flow of the protected service and are transported on the same time-slice as other IP flows of the protected service, thereby having a similar forward error correction (FEC) as other IP data flows in the system 300. Moreover, the terminal 500 is thereby also dormant, namely “sleeps”, during bursts of data flow in the system 300. With reference to DVB CA (Digital Video Broadcast Conditional Access), the TEK stream of data 460 effectively corresponds to a data stream conveying ECMs (Entitlement Control Messages). Messages present in the stream of data 460 beneficially each include a dynamic portion thereof conveying IPsec security associations which are employed in the system 300 to secure IP data flows of the protected service provided therein. Moreover, the messages present in the stream of data 460 also each include a static portion thereof which is distributed in a SDP (Service Discovery Protocol) file that describes IP flows occurring at the terminal 500. The SEK key 445 is beneficially changed periodically, for example every few hours, to enhance security within the system 300.

In the layer 3, a service encryption key (SEK) is identified with its corresponding DRM content ID (BCI, Binary Content Identity) and delivered from the network 400 to the terminal 500 in a protected rights object (RO). The RO is optionally delivered over the broadcast pipeline 320 configured to function as an interaction channel. Alternatively, the RO is optionally delivered over the broadcast channel 320 configured to function as a broadcast channel, namely not supporting interaction between the network 400 and the terminal 500. Yet more optionally, the RO includes the SEKs of all services belonging to a service bundle; such an RO optionally has a single set of usage rules applicable to all bundled services provided in the system 300; such a single set of rules provides for efficient data exchange in the system 300. The layer 3 is also capable, for example, of providing parental control in a cryptographic manner by authenticating an individual rather than the terminal portion 500, thereby binding the RO to that individual.

In the layer 4, device registration is implemented, namely registration of the terminal 500 to the system 300. Such registration is achieved by way of certificates that later enable confidential and authenticated communication between the network 400 and the terminal 500. In the system 300, the keys 485, 610 thus perform a registration function.

Key streams occurring in the system 300 will now be further elucidated. Key streams, namely the data streams 460, 490 in the system 300, each consist of a sequence of key stream messages which are each separately encapsulated in a UDP (User Datagram Protocol) packet. Each message has a format as depicted in Table 1 commencing with a start of the message at the top of Table 1 and an end of the message at the bottom of Table 1.

TABLE 1
Message format

| Format (4 bits): | Reserved | Reserved | Authentication identification | Next identification |
|---|---|---|---|---|
| 0000 | (1 bit) | (1 bit) | (1 bit) | (1 bit) |

Upper-layer re-keying index (URKI, 3 bytes): this data field is always present; for OMA DRM as the
upper layer in the system 300, this field contains the last 3 bytes of a corresponding CID or BCI
Lower-layer re-keying index (LRKI, 4 bytes): the data field is always present; for IPsec as the lower
layer, this field contains the SPI
Traffic encryption key (TEK [LRKI]): this data field is always present; the length of this data field is
defined by the encryption algorithm used, for example in the encryptors 450, 480; the length of this field is
16 bytes for AES; this data field is encrypted by using SEK[URKI]
Traffic encryption key (TEK[LRKI+1]): this data field is present if the Next Indication at the beginning of
the message is set to a value 1; the length of this data field is defined by the encryption algorithm used in
the encryptors 450, 480; the length of this field is 16 bytes for AES; this data field is encrypted by using
SEK[URKI.
Message authentication code: this data field is present if the Authentication Identification at the beginning
of the message is set to a value 1; the length of this data field is defined by the authentication algorithm
used in the system 300; this data field has a length of 16 bytes for AES.

In Table 1, the 4-byte LRKI enables a TEK to be changed every second for 136 years. Moreover, a 3-byte URKI enables a SEK to be changed every second for 31 years; optionally, the SEK is changed every hour or every day to enhance security within the system 300.

Rights acquisition in the system 300 will now be described. When the broadcast channel 320 is configured to function as an interaction channel between the network 400 and the terminal 500, all aspects of rights objects (RO) acquisition, for example device registration, local domain management, right object delivery, are addressed using procedures as defined in the aforementioned OMA DRM specification. Conversely, when the broadcast channel 320 is configured to provide single direction communication, namely not as an interaction channel, other key management operations are required to implement the present invention.

When the broadcast channel 320 is not configured to provide interactive communication, in order to allow for efficient delivery of rights objects (ROs) over the broadcast channel 320, DRM ROs must be made as small as possible to reduce their bandwidth requirement when being communicated within the system 300. One or more approaches according to the invention to render DRM ROs smaller are provided in Table 2.

TABLE 2
Approaches to reduce DRM RO size

| Approach | Details of approach |
|---|---|
| 1 | By a substitution of tags, for example Extendable |
| | Markup Language (XML) text is converted to a binary |
| | equivalent when compressing rights objects. |
| 2 | By a substitution of CID (Content Identification), |
| | for example a CID string is converted to an equivalent |
| | BCI (Binary Content Identity) value. |
| 3 | By a substitution of numbers, for example decimal |
| | numbers are converted to binary equivalents. |
| 4 | By a substitution of signature, for example converting |
| | asymmetrical signatures to symmetrical signatures. |
| 5 | By data compression. |

Such data compaction approaches are operable to generate a binary rights object which is conveniently referred to as a Broadcast Rights Object (BRO).

Issues concerning the BCI (Binary Content Identity) will now be further described. A textual CID of a given service has a form cid:<service spec>. Its binary derivative BCI (Binary Content Identity) is define by cidhash (″cid:<service spec>) wherein cidhash is a hash function, for example pursuant to AES, CBC and MAC. The hash function optionally has a fixed hash key. In order to use a sequence of ROs of limited validity to protect a key stream of the service provided in the system 300, a CID which is included within a RO is optionally extended with the aforementioned 3-byte URKI which is carried in the key stream, for example from the encryptors 450, 480. The URKI cannot be subjected to a hash function as too much information loss would thereby result for the system 300 to function.

In operation, at the network 500, one or more rights objects (ROs) received thereat are added to an RO database thereat. The one or more ROs optionally include keys for multiple services, each service being identified by a CID (Content Identification) or a BCI (Binary Content Identity). It is desirable, as further elucidated later, for example by way of indexing, that one or more ROs corresponding to a given CID or BCI can be efficiently looked up at the terminal 500.

Reception of data content at the terminal 500 will next be described. When the user invokes the media player 550, a key manager in the terminal 500 is operable to check that IP addresses from which streams of data content, namely media streams, are conveyed are included in an active security policy maintained at the terminal 500. If the addresses are not included in the active security policy, the terminal 500 proceeds to determine whether or not the security policy needs to be updated. The terminal 500 proceeds to receive ECM streams from the addresses which provide information regarding whether or not the policy should be updated. Operation of the terminal 500 to update its security policy will be further elucidated with reference to FIG. 4.

In FIG. 4, a key manager provided at the terminal 500 is denoted by 700. Moreover a DRM agent provided thereat is denoted by 800; the key manager 700 and the DRM agent 800 can, for example, be implemented using software executable on computing hardware. The key manager 700 includes a DCF (DRM Content Format) assembly 710 and a SA (Security Association) assembly 720, these assemblies 710, 720 being configured to receive SDP (Service Discovery Protocol) data 900 from an ESG (Electronic Service Guide) database 730. The DRM agent 800 comprises a rights object (RO) database 820 and a DRM decryptor 810, namely effectively an implementation of the aforesaid decryptor 590. The DCF assembly 710 is operable to receive TEK messages 910 and output TEK messages to the SA assembly 720 as well as output DCF data 940 to the DRM decryptor 810. The SA assembly 720 is, in turn, operable to output security associations (SAs) 930 to a security association database 740. The rights object database 820 is operable to output stored rights object (RO) data 960 to the DRM decryptor 810 which, in turn, outputs clear DCF data 950 to the SA assembly 720. The DRM encryptor 810 is arranged to receive the key 610 as also depicted in FIG. 3.

At a moment a TEK message 910 is received at the DCF assembly 710, the key manager 700 present in the terminal 500 is operable to execute one or more of the following steps:

(a) authenticate the TEK message, if defined in the SDP data 900;

(b) look up, fetch via an interactive channel if available, or prompt the user to obtain a correct rights object (RO) from the rights object database 820 and decrypt encrypted parts of the TEK message; such decryption invokes use of the DCF assembly 710 and the DRM decryptor 810;

(c) construct and activate a security association containing the TEK included in the TEK message received and some data from the SPD data 900, for example one or more IP destination addresses of media, namely data content, streams; and

(d) construct and activate a next security association, for example when the next indicator field in the TEK messages is set to a value 1, optionally with an expiry time. The key manager 700 operating in conjunction with the DRM agent 800 at the terminal 500 are capable of reconstructing a DCF. Moreover, the DRM agent 800 is susceptible to being implemented as an OMA-compliant DRM agent as elucidated in the foregoing.

Reception of IP (Internet Protocol) packets at the terminal 500 will now be described. When an IP packet is received at the terminal 500, an IP packet corresponding to an active security policy, IPsec processing is executed at the terminal 500 on the IP packet. Such processing is fully defined in contemporary IPsec protocols. Such protocols involve a security association being identified from the security association database 720, and the IP packet is decrypted using the TEK provided which is a part of the security association as will be further elucidated later.

When a user at the terminal 500 elects to terminate media consumption, the key manager 700 stops receiving the TEK messages conveyed in data streams 460, 490. Security associations in the security association database 740 are allowed to lapse as appropriate, for example controlling a duration or number of times a given media stream can be accessed by the user using the terminal 500.

In overview, contemporary data content communication systems, for example digital video broadcast (DVB) systems conforming to the aforementioned OMA DRM 2.0 standard regarding handling of rights objects (RO), are operable such that rights objects (RO) 1000 therein use textual identifiers 1010 to associate encrypted data content 1020 therewith as depicted in FIG. 5, such association being denoted by an arrow 1025. Thus, when pairing rights objects (RO) 1000 and corresponding ECM messages 1030 in such communication systems, such pairing being denoted by an arrow 1035, there arises a technical problem of there being an inconveniently large data overhead of OMA textual identifiers in such corresponding ECM messages 1030. The present invention provides at least a partial solution to this technical problem by appropriately transforming the textual identifiers 1010 so that they are more compact. In embodiments of the invention described later, various approaches are provided for such data compacting of textual identifiers 1010; examples of such approaches are provided in Table 2 in the foregoing.

These approaches adopted when implementing the present invention generally involve mapping textual Open Mobile Alliance (OMA) uniform resource indicators (URI) onto corresponding numbers at a transmitter, for example at the network 400. Moreover, the methods of the invention further involve reversibly mapping these numbers onto the uniform resource indicators (URI) at a corresponding receiver, for example the terminal 500, such that the numbers and hence their uniform resource indicators allow for corresponding rights objects (RO) 1000 to be obtained. Thereafter, content encryption keys associated with the aforesaid rights objects (RO) 1000 are used to decrypt corresponding entitlement control messages (ECMs) 1030. Optionally, each entitlement control message (ECM) 1030 conveys a corresponding number; optionally, a hash function or similar, as elucidated in more detail later, is employed for mapping each entitlement control message (ECM) 1030 to its corresponding number. The hash function is optionally implemented by way of contemporary Message Digest RFC 1320/1321 such as MD4 or MD5, by way of a contemporary hash algorithm such as SHA-1 Secure Hash Algorithm (FIPS 180-2), or by way of a contemporary advanced encryption standard (FIPS 197) (AES) operating in a CBC-MAC mode utilizing a public symmetrical key.

In a first approach to implementing the present invention, relative document type definitions (DTD) are not altered when associating the data content 1020 with corresponding entitlement control messages (ECMs) 1030 and rights objects (ROs) 1000. Conversely, in a second approach to implementing the present invention, DTDs are altered when associating the data content 1020 with corresponding entitlement control messages (ECMs) 1030 and rights objects (ROs) 1000. These embodiments of the present invention will now be further elucidated in overview.

In the context of the first approach, the aforesaid OMA DRM 2.0 standard uses a uniform resource indicator (URI) to reference a right object (RO) from a digital rights management (DRM) content format abbreviated by DCF. A format for the URI is, for example, as defined in a standard RFC 2392; the URI optionally comprises a content identifier (cid) and a universal resource locator (url). The URI is contemporary United States (US) ASCII-based which renders such URIs too large, namely including too many bytes, to be incorporated into an entitlement control message (ECM) 1030 typically restricted to 184 bytes or less. The content identifier (cid) is used to define an address specification with the uniform resource location (url) for use in identifying corresponding data content. An example of such a content identifier (cid) is:

cid:movie123@philips.com

The URI expressed as a textual identifier is, in the present invention, transformed to a corresponding binary identifier by way of a collision-free hash function. The hash function is optionally implemented so that its aforesaid binary identifier is restricted to an upper limit; the upper limit is optionally 128 bits for a MD4/MD5 hash function, or 160 bits for an aforesaid SHA-1 type hash function. The SHA-1 hash function is capable of exhibiting especially appropriate collision properties and is already used for other purposes in a contemporary federal information processing standard (FIPS) and accepted by the Open Mobile Alliance (OMA); as elucidated earlier, SHA is an abbreviation for secure hash algorithm, for example pursuant to the contemporary FIPS 180-2 standard. As an alternative to using such a hash function, advanced encryption can be utilized, for example by employing an advanced encryption standard (AES) pursuant to FIPS 197; such advanced encryption optionally employs a public symmetric key. AES is of benefit in that it is capable of being implemented in hardware, for example as in contemporary smart card security controllers. When advanced encryption is employed, such encryption can be implemented such that a public hash key denoted by “public_hash_key” is a 16-byte random key. Moreover, the aforesaid content identification (cid) is in such case assigned a corresponding address specification denoted by “addr-spec”. Furthermore, the universal resource locator (url) is implemented as “cid” “:” content_id, for example as in an example described in the foregoing. There thereby in the first approach to implementing the invention is determined a binary_content_id by way of function as expressed in Equation 1 (Eq. 1):
binary_content_id=ƒ([public_hash_key], <cid-url>) Eq. 1

In regard of the aforesaid rights object (RO) 1000, it includes a universal identifier <uid> element which is of equivalent value to the aforesaid cid-url. Thus, the aforesaid binary_content_id of Equation 1, in the first embodiment, is preferably included in the ECM 1030.

At a receiver configured pursuant to the present invention, for example at the terminal 500, when implementing the first approach, the ECM 1030 is received and the receiver is operable to extract therefrom the binary_content_id. The receiver is then operable to search its internal cache list to find the corresponding rights object (RO) 1000 using the binary_content_id as a search key. In searching for the rights object (RO) 1000, when a match is successfully found, namely a cache “hit” successfully occurs, a content encryption key included in the rights object (RO) is used in the receiver to decrypt the ECM 1030. In an event that a match is not successfully found, the receiver can optionally externally therefrom, namely in offline storage, search for rights objects (RO) and, in an event of a match being found, calculate therefrom the binary_content_id; in such an event, corresponding rights objects (RO) can be imported to the receiver. If no corresponding match can be identified, the receiver interprets such a lack of match, namely a lack of a “hit”, as being indicative that the receiver does not have a right to access the encrypted data content 1020 provided thereto from the network 400.

In the two approaches to implementing the present invention elucidated in the foregoing, rights objects (RO) may include a textual identification, or both a textual identification and a numerical identification. The ECM 1030 pursuant to the present invention will always include a numerical identification. A receiver configured pursuant to the present invention, for example the terminal 500, is operable to search directly to identify rights objects (RO) having a corresponding numerical identification similar to that in an ECM it has received, or alternatively apply a function to right objects (RO) accessible to the receiver to generate numerical identifications which it then subsequently compares with that in the ECM it has received. A characteristic of the function is that it does not allow for textual identification to be generated from the numerical identification on account of some information loss occurring when earlier generating the numerical identification from the textual identification. The information loss however is not so significant that the receiver is unable to determine which rights objects (RO) are appropriate for given data content received thereat from the transmitter.

In the context of the second approach, document type definitions (DTDs) are altered when associating the data content 1020 with corresponding entitlement control messages (ECMs) 1030 and rights objects (ROs) 1000. When a system comprising the aforementioned transmitter and receiver pursuant to the present invention, for example the network 400 and the terminal 500 respectively, is arranged to function pursuant to the second approach, renaming occurs such that a following element, for example pursuant to the contemporary OMA DRM 2.0 standard, is modified as provided in Equation 2 (Eq. 2):
<!ELEMENT o-ex: context (o-dd:version?, o-dd:uid*)>
is modified to
<!ELEMENT o-ex:context (o-dd:version?, o-dd:uid*, o-ex:digest*)> Eq. 2

After renaming the document type definitions (DTDs), the aforesaid hash function is calculated for a cid-url for the renamed document, the hash function being described by ƒ([public_hash_key], <uid>). Thereafter, for example by using the aforementioned SHA-1 type algorithm, a composite element denoted by “digest” defining renaming employed is determined, namely a <DigestMethod> parameter and a <DigestValue> parameter. Thereafter, a similar procedure as adopted in the first approach is utilized.

In a first implementation of the system 300 pursuant to the present invention, its network 400 is operable to employ DVB-CSA scrambling using a common scrambling algorithm (CSA) such that the data conveyed via the broadcast channel 320 coupling the network 400 to the terminal 500 conforms to contemporary MPEG-2 TS format; MPEG is an abbreviation for “Motion Pictures Expert Group”. Optionally, when the aforesaid network 400 executes DVB-CSA, the terminal 500 includes a DVB-CSA descrambler.

In a second implementation of the system 300 pursuant to the present invention, the network 400 is operable to employ IPsec/ESP encryption such that the data conveyed via the broadcast channel 320 conforms to IP-DC (Internet protocol Data Cast). When the network 400 executes IPsec/ESP encryption, the terminal 500 is correspondingly implemented so as to execute IPsec/ESP decryption.

It is to be appreciated that the system 300 pursuant to the present invention is susceptible to being configured to provide digital video broadcast (DVB) services to numerous receivers, for example several terminals 500, coupled to a transmitter, for example to the network 400, each such receiver being potentially assigned mutually different data content utilization rights regarding data content conveyed from the transmitter thereto. Thus, in the aforesaid implementations of the system 300 implementing the aforementioned approaches, an issue arises concerning synchronization of decryption keys and content between the transmitter and one or more such receivers. The first and second implementations of the system 300 pursuant to the present invention allow for registration and rights management using the broadcast channel 320.

When implementations of the system 300 are operable to function according to the DVB 1.0 standard, synchronization of decryption keys and data content conveyed in MPEG-2 format is optionally established utilizing the DVB 1.0 standard. However, when IP-DC operation is implemented using IPsec/ESP encryption of data content, a method of synchronization is known from a published U.S. Pat. No. 6,668,320. In a situation of MPEG-2 data conveyed by way of the broadcast channel 320 of the system 300, a right issuer certificate chain can be established within the system 300 by employing a rights issuer identity and certificate chain, and a rights issue identity and a DRM time signed by the rights issuer. In such an implementation, the terminal 500 is operable first to validate the right's issuer's certificate chain using its root certificate and thereafter use a public key included within the certificate to verify a corresponding signature by way of a right user identity. In a situation in which the signature is found to be valid, the terminal 500 of the system 300 is thereby capable of creating or recreating an issuer context.

Embodiments of the present invention, for example the system 300, are operable, as a goal, to deliver protected data content over IPDC infrastructure to one or more receivers, for example to the terminal portion 500. These embodiments of the invention achieve the goal by employing a series of interactions as depicted in FIG. 6. The one or more receivers are, for example, handheld devices susceptible to receiving IP packet streams, for example for providing the one or more terminals with video rendering capabilities. The IP packet streams can be, for example, protected or unprotected. Moreover, data content conveyed by such packet streams can be data files, for example to be consumed by some file consuming applications executing on the one or more terminals, or alternatively streamed data, for example to be consumed by streaming applications executing on the one or more terminals for implementing television. The communication network, for example the broadcast network 320, over which the IP data packets are conveyed can be IP-DC over DVB-H, with or without cellular communication as an interaction channel, and various cellular networks, for example supporting point-to-point data connections susceptible to coping with multicast of broadcast using IP-based protocols. Thus, embodiments of the present invention are susceptible to being presented with a spectrum of different types of communication network. In FIG. 6, there is shown a variety of services provided in the system 300 from data content providers, namely the network 400, to one or more terminals, for example the terminal 500. The network 400 includes content sources denoted by 1100 whose data content is susceptible to being conveyed via IP-DC over DVB-H denoted by 1110 through the broadcast channel 320 to streaming applications 1130 or to data files 1140 of a terminal denoted by 1120. Alternatively, the data content provided from the content sources 1100 is also susceptible to being conveyed a cellular communication path denoted by 1200 through the broadcast channel 320 to the streaming applications 1130 or the data files 1140. There is further data interaction denoted by 1210 via the cellular communication path 1200 for coupling the terminal 1120 to one or more purchase points 1220, for example for receiving rights objects (RO) in return for payment.

Thus, with reference to FIG. 6, the terminal 1120 implemented as a handheld device is capable of receiving IP packet streams, for example video rendering capabilities, wherein several of the sources 1100 are operable to deliver both protected and unprotected data content. The system 300 pursuant to the present invention can be based on one or more contemporary standards as listed in Table 3.

TABLE 3
Contemporary standards with which the present invention is susceptible to being implemented

| | Reason for using standard to implement the |
|---|---|
| Standard | present invention |
| Advanced Encryption Standard (AES) | AES is an efficient symmetrical encryption |
| providing chaining mode with 128 bit keys for | method, namely an open standard which is also |
| actual content encryption. OMA DRM uses | implemented in hardware. |
| AES-WRAP in its rights objects (RO) and | |
| optionally an AES CBC-MAC | |
| Secure Internet Protocol (IPsec) using | IPsec/ESP is a standard approach to keep content |
| Encapsulating Security Payload (ESP) protocol | decryption at data content receiving terminals within an |
| for implementing data content encryption and | IP stack, namely invisible to receiving applications |
| decryption as a function of an IP stack. Both | executing at the receiving terminals. The content |
| tunneling and transport modes of operation are | decryption can thus be independent of service protection |
| supported, although the transport mode is | and carriers of IP packet streams. |
| anticipated to be more efficient when | |
| implementing the present invention. | |
| Traffic key protocol and management | Traffic key management framework and protocol |
| specification are beneficial used; these are not | provide efficiency and robustness and accommodates |
| based on an existing standard but on a | frequent changing of traffic keys (TEKs) |
| specification in a companion document which | |
| is a normative appendix. | |
| Open Mobile Alliance (OMA) using Digital | OMA DRM 2.0 renders IP-DC a part of a value chain |
| Rights Management (version 2.0 (OMA DRM | which can be used for selling content and services in |
| 2.0) for managing rights to services, associated | cellular environments. |
| service keys (SEKs) and cryptographic | |
| protection of these service keys. | |
| DRM rights object (RO) delivery and device | OMA DRM 2.0 uses interaction over a two-way |
| registration over IP-DC, without using an | communication channel for device registration and |
| interaction channel, are also new standards. | guaranteed rights delivery. It can be adapted for receive |
| | only devices. |

It will be appreciated that the embodiments of the present invention implemented to execute methods of associated data content with rights objects pursuant to the present invention can be arranged in a wide variety of potential systems architectures. One such architecture is depicted schematically in FIG. 7. A practical architecture for the system 300 operable according to the present invention is indicated generally in FIG. 7 by 2400. The system 2400 includes an IPsec/ESP simulcryptor 2410 for receiving unprotected Internet protocol (IP) data content 2415; as elucidated earlier, “IPSEC” is an abbreviation for Internet protocol security and “ESP” is an abbreviation for encapsulating security payload. The simulcryptor 2410 is coupled in communication with a control word generator 2420 for exchanging control word (CW) data 2425 therewith. Moreover, the simulcryptor 2410 is also connected to a key container message (KConM) generator 2430 configured pursuant to Open Mobile Alliance (OMA) standards, the message generator 2430 being operable to exchange control word (CW) data and key container messages (KConM) with the simulcryptor 2410. The key container message (KConM) is an opaque data structure that contains a traffic key (TEK) message, or in the case of digital video broadcast (DVB) an ECM message. The simulcryptor 2410 includes an output 2440 for conveying protected Internet protocol (IP) data content in addition to the key control messages (KCM) and key container messages (KConM) to a MultiProtocol encapsulation unit 2450. The encapsulation unit 2450 is configured to be operable to encapsulate the data content provided at the output 2440 taking into account associated rights objects (ROs) and DRM format content format (DCF) data 2455 for generating aforementioned MPEG-TS output data 2460 which is conveyed to a multiplexer 2465 for subsequent transmission by way of one or more of fiber optical data transmission 2470a, satellite dish transmission 2470b and DVB-H terrestrial tower wireless transmission 2470c. The system 2400 further includes a rights issuer 2500 conforming to aforementioned OMA standards, the rights issuer 2500 being operable to selectively release content encryption keys 2505 to the message generator 2430, and to a DCF encryptor 2510 conforming to aforementioned OMA standard. The rights issuer 2500 is coupled to a data object carousel 2520 for conveying right objects (RO) 2515 thereto; the right objects (RO) 2515 are optionally 1-pass ROAP and also are optionally in binary format. Additionally, the rights issuer 2500 is connected to an interactive channel Internet protocol (IP) gateway 2530 configured for cellular networking, the issuer 2500 being operable to convey rights objects (RO) 2525 thereto; the rights objects 2525 are optionally in a 2-pass ROAP format and are accompanied by device registrations in a 4-pass ROAP format; “ROAP” is an abbreviation for contemporary rights object acquisition protocol. The DCF encryptor 2510 is coupled to receive unprotected Internet protocol (IP) data content 2540 and is operable in response to receiving the encryption keys 2505 to generate DCF data 2545 for output to a DCF (DRM format control format) data store 2550; “DRM” is an abbreviation for data rights management or digital rights management. The store 2550 is operable to provide retrieved DCF data 2555 to the data object carousel 2520. Moreover, the store 2550 is also operable to output retrieved DCF data 2560 to the IP gateway 2530. The gateway 2530 in turn is operable to output data 2565 which is transmitted from a UMTS radio tower 2570 or similar wireless emitter adapted for cellular networks. “UMTS” is an abbreviation for universal mobile telecommunications system as employed in contemporarily providing cell phone, namely mobile telephone, communications infrastructure.

Data output from the system 2400 is susceptible to being received at a variety of receivers 2600, for example including one or more of a television 2605, a cell phone or mobile telephone 2610 or a hand-held computer 2615 also known as a palm-top computer.

In operation, the system 2400 is operable to merge the unprotected IP data content 2415, 2540 with rights objects (RO) provided from the rights issuer 2500 as represented by one or more generated numerical identifications as will be elucidated later, and message data from the control word generator 2420 and the key message generator 2430 to provide output data content for receipt at the receivers 2600, these receivers 2600 being optionally implemented in a manner akin to the terminal 500. Such merging of data in the system 2400 is performed pursuant to methods of the invention elucidated in the foregoing with regard to reduced ECM message bandwidth by applying the aforesaid hash and/or encryption functions, for example as elucidated with reference to Table 2 in the foregoing. As illustrated in FIG. 7, the system 2400 is potentially versatile and capable of servicing a variety of types of receiver 2600, for example mobile telephones, cells phones, televisions, personal data assistants (PDAs) and similar.

Referring next to FIG. 8, there is shown another practical architecture of the system 300 indicated generally by 2700, the system 2700 being operable pursuant to methods of the invention. The system 2700 comprises a rights issuer 2710; optionally, the issuer 2710 conforms to the aforementioned Open Mobile Alliance (OMA) standard. The issuer 2710 is operable to output rights objects (RO) 2715, the rights objects 2715 optionally being in 1-pass ROAP form and also in binary format. Moreover, the rights issuer 2710 is also operable to output content encryption keys 2725 to an entitlement control message (ECM) generator 2730, the message generator 2730 optionally conforming to the aforesaid OMA standard. Furthermore, the rights issuer 2710 is also operable to output device registrations 2720, such device registrations being optionally in 4-pass ROAP format; as elucidated in the foregoing, “ROAP” is an abbreviation for contemporary rights object acquisition protocol.

The system 2700 further comprises a rights object (RO) carousel 2740, the carousel 2740 optionally conforming to the OMA standard. In turn, the carousel 2740 includes an output 2745 for outputting rights objects (RO) in addition to associated management message data 2745 to a multiplexer 2760. The multiplexer 2760 is coupled at its multiplexed output to a DVB common scrambling unit 2765, and is also operable to receive entitlement control message (ECM) data 2775 from a simulcrypt synchronizer (SCS) 2780. The synchronizer 2780 comprises an output 2785 for providing control word (CW) data to the scrambling unit 2765. Moreover, the scrambling unit 2765 includes an output for providing transmission data for subsequent transmission by way of one or more of fiber optical data transmission 2470a, satellite dish transmission 2470b and DVB-H terrestrial tower wireless transmission 2470c. The synchronizer 2780 is itself provided with control word (CW) data 2795 from a control word generator 2800.

The system 2700 includes an interactive channel Internet protocol (IP) gateway 2810 for receiving the device registrations 2720. The gateway 2810, in cooperation with the UMTS radio tower 2570 is operable to provide communication over cellular networks, namely mobile telephone or cell phone networks, for handling device registrations, for example registrations in regard of the system 2700 for one or more of the receivers 2600. The system 2700 is operable to convey processed data content to the receivers 2600, the processed data content including data content together with rights objects (RO) and entitlement control messages (ECM) wherein these are associated pursuant to the present invention, namely using fewer data bytes by way of use of a hash function and/or encryption as elucidated in the foregoing. The system 2700 is optionally operable to function according to the OMA standard with DVB 1.0 common scrambling as mentioned earlier.

In the systems 10, 300, 2400, 2700, OMA DRM 2.0 rights objects are included and represent considerable data such that it is not reasonably feasible to employ broadcast-only channels provided by these systems 10, 300, 2400, 2700 to distribute uniquely encrypted rights required to support DVB-H data content. Conveniently, during registration of receivers 2600 within the systems 2400, 2700, it is desirable that each receiver 2600, namely each client or terminal of the systems 2400, 2700, becomes a member of a group of clients known as a broadcast domain. In operation of the systems 2400, 2700, several broadcast domain keys, for example including a batch key, are loaded into the group of clients. The receivers 2600, namely clients, thereby become registered into the systems 300, 2400, 2700. After registration, it is operationally beneficial that all addressing is broadcast-domain based. For example, each client, namely receiver 2600, can be given access to a content encryption key encapsulated in binary rights objects (BRO). Optionally, the binary rights objects (BRO) are encapsulated in a cryptographically secure manner using broadcast encryption. More optionally, the content encryption key can be exclusively-ORed, namely subject to a logical exor-ing function, with a random number included in electronic content messages (ECM) conveyed by the systems 300, 2400, 2700 to their receivers 2600.

When the present invention is applied in the context of DVB-H, two modes of operation are feasible, namely a connected mode or an unconnected mode. Thus, each receiver 2600 in the connected mode is operable to receive information data from which rights objects (RO) can be determined, said information data being conveyed via the broadcast channel and via an Internet protocol (IP) channel, for example provided in practice via a GPRS or UMTS connection. Alternatively, each receiver 2600 in the unconnected mode is operable only to use a one-way broadcast channel to receive information data for determining rights objects (RO).

The data communication systems 10, 300, 2400, 2700 are susceptible to being executed, at least in part, using computing hardware operable to execute software. Alternatively, the systems 300, 2400, 2700 can be implemented using various combinations of dedicated electronic hardware.

As shown in FIG. 3 and elucidated in its associated description, the present invention concerns a three-level cryptographic architecture, wherein rights management layer security is guaranteed by OMA DRM 2.0 and its secure implementation at receivers of terminals, for example at the terminal 500 and at the receivers 2600. In the systems 300, 2400, 2700, rights objects (RO) carrying service keys (SEKs) are broadcast, optionally employing symmetrical rights keys instead of asymmetrical public and private keys. Optionally, data content encryption in the systems 300, 2400, 2700 is executed pursuant to AES using 128 bit symmetrical traffic keys (TEKs). Moreover, beneficially, encrypted data content streams are broadcast to one or more port numbers of a single IP address employed in the systems 300, 2400, 2700.

In the systems 10, 300, 2400, 2700, traffic keys (TEKs) are optionally applied as part of standard IPsec security associations (SAs); once a terminal of the systems 300, 2400, 2700 has available thereto a plaintext SA for decrypting data content streams broadcast to an IP address, the SA, including a receiver IP address as stream identifying information and a traffic key (TEK), is optionally made available to an IPsec decryption function of an IP stack of the terminal. IP packets sent to the receiver IP address, namely to all its port numbers, are capable of being automatically decrypted before being passed to a receiving application, for example the media player 550, executing at the terminal, for example the terminal 500.

The SAs are themselves broadcast to the terminal in encrypted form, but not at an IPsec level. From an IP stack point of view, the SAs are in plain text, but each encrypted by a service key (SEK) at a DRM level. Broadcast messages conveying SAs are therefore susceptible to being regarded as traffic key (TEK) messages on account of them effectively conveying the traffic keys in an SA format. Thus, from an IP stack point of view, traffic key (TEK) messages must be sent to another IP address. In the systems 10, 300, 2400, 2700, once received in the traffic key (TEK) messages, the SAs are in encrypted form, namely encrypted by service keys (SEKs), and cannot directly be used for decrypting data content.

One or more proper service keys (SEKs) for decrypting the SAs are transmitted in the systems 300, 2400, 2700 to terminals thereof, for example the terminal 500, within OMA DRM 2.0 rights objects (ROs) using aforementioned service key (SEK) messages. Such transmission of service key (SEK) messages can be executed in two different ways, depending in whether or not the receiving terminal is able to utilize a separate interaction channel. However, in either situation, the ROs can only be utilized by the receiving terminal, on account of the service key (SEK) part of them being protected according to the OMA DRA 2.0 standard. The service key (SEK) protection provided in the systems 10, 300, 2400, 2700, is based, according to OMA DRM 2.0 on a public key cryptosystem wherein a corresponding public key for the receiving terminal is registered at each rights issuer and the corresponding private key is kept by a DRM module, for example the 560, in the receiving terminal. The DRM module 560 never reveals the private key to other applications executing at the receiving terminal, let alone other parts of the system 300, 2400, 2700. The management of the rights objects (ROs) is also addressed by the DRM module 560.

A process whereby the terminal 500 is able to obtain some protected data content from the network 400 will now be described with reference to FIG. 9; the process is indicated generally by 3000. A receiving terminal is denoted by 3010, for example similar to the terminal 500. Moreover, a DRM module for handling rights keys, namely rights objects (RO), is denoted by 3020, namely similar to the aforementioned module 560. Rights keys belonging to a rights issuer are denoted by 3060, 3050 respectively. Moreover, a web shop is represented by 3040. Furthermore, a human user is denoted by 3030.

In a first step 3110 of the process 3000, the terminal 3010 registers with the rights issuer 3050 so that the rights issuer 3050 becomes aware of a public key of the terminal 3010. In a second step 3120 of the process 3000, a purchase transaction is executed, either by the terminal 3010 itself or by another approach, for example a telephone call or World Wide Web purchase by the user 3030. Next, in a third step 3130, a corresponding purchase transaction is communicated to the rights issuer 3050. In a fourth step 3140, the rights issuer 3050 creates a rights object (RO) for the terminal 3010 and protects the service key (SEK) therein so that it is accessible by the public key of the terminal 3010. In a step 3150 occurring within the terminal 3010, the rights object (RO) is conveyed to the DRM module 3020. If ROs are renewed automatically, the fourth step 3140 is repeated across an interaction channel or across an IP-DC broadcast channel.

The process 3000 relies on their being interaction from the terminal 3010 In FIG. 10, there is shown a process for obtaining protected data content when interaction is not available; the process is indicated generally by 4000. The process 4000 involves use of an ESG application 4020 akin to the aforementioned ESG application 510, an IP streaming consuming application akin to the aforesaid media player 550, an IP stack 4030 including IPsec handling 4040 and a DRM rights module 4050 akin to the module 560. When executing the process 4000, in a first step 4100 thereof, the user 3030 identifies data content to be received, for example using the electronic service guide (ESG) application 4020. In a second step 4110, based on data in the ESG application 4020 and associated service descriptions, two IP addresses for receiving both streamed data content and traffic key (TEK) messages are identified and reception thereof is then commenced. In a third step 4120, as each traffic key (TEK) is received, an encrypted SA therein is handed to the DRM module 4030. In a fourth step 4130, the DRM module 4050 now momentarily decrypts one or more ROs using a private key whilst internally momentarily revealing corresponding one or more service keys (SEKs). The DRM module 4050 uses the one or more service keys to decrypt the SA and then proceeds to reveal the SA, for example in the terminal 500. The SA is handed to the IP stack 4030 which, in a fifth step 4140, is used for decrypting the content stream, for example consumed by some standard IP socket application such as the media player 550.

Registration of data content receiving devices, for example the terminal 500, within the systems 300, 2400, 2700 is an important issue for the present invention. When OMA device registration is implemented for one-way broadcast channels, for example the channel 320, OMA DRM 2.0 device registration uses a 4-pass Rights Object Acquisition Protocol (ROAP). This registration protocol requires a two-way communication channel. For some applications, for example IP-DC using DVB-H as a bearer, such a two-way communication channel is not available. Therefore, the present invention utilizes an alternative way of registering a compliant device, for example the terminal 500, which is conveniently defined as 1-pass ROAP. Minimum data that is required for implementing such 1-pass ROAP from a rights issuer is:

(a) a rights issuer certificate including a root certificate chain;

(b) a rights issuer identity, for example a SHA-1 type hash of a DER-encoded public key;

(c) a DRM time; and

(d) broadcast-specific key material and metadata.

Moreover, minimum data required by the rights issuer required by the rights issuer from the data content receiving devices include:

(e) a unique certificate from the device including a rooted certificate chain;

(f) an identity of the device, for example A SHA-1 hash of a DER-encoded public key for the device; and

(g) a definition of capabilities of the device.

The rights issuer is capable of obtaining the certificate unique to the device and the definition of capabilities of the device from an authority using the device's identity as a search key. The device then obtains the rights issue certificate chain, the rights issue identity and broadcast specific key material and metadata by way of two messages; these two messages include the identity of the rights issuer and the certificate chain, together with broadcast specific key material and metadata.

The rights issue identity and certificate chain messages are broadcast to listening devices and repeated for, optionally, an unlimited period of time on intervals of 1 minute or less. Such listening devices first validate the right issuer's certificate chain using the certificate chain and its root certificate. Thereafter, if validation is successful, the listening devices are able to create or recreate an issuer context and store the rights issuer's public key.

The broadcast specific key material and metadata message is addressed to only one device and repeated for a limited period of time. For example, it is assumed that when the user 3030 registers his or her device to an operator; the device, for example the terminal 500, is switched on and able to receive registration data for the device within 1 minute or less. Upon receiving the message, the device first validates the issuer's identity, namely signature, and, if found to be valid, decrypts a corresponding payload using its private key. The broadcast specific key material and metadata is then placed in the issuer's content in the device.

A further important issue when implementing the present invention is OMA rights management for one-way broadcast channels. OMA DRM 2.0 rights objects (ROs) include both redundant and lengthy textual parts; for broadcast applications, these ROs thus use an inefficient addressing scheme and thus represent a technical problem. To address this problem, the present invention provides a solution which utilizes a binary representation of OMA DRM 2.0 rights objects (ROs) and an addressing scheme which, in combination, provide enhanced efficiency with respect to bandwidth use. The solution will now be further elucidated.

With regard to binary representation of OMA DRM rights objects (ROs), OMA DRM 2.0 rights expression language is based on extended markup language, namely XML 1.0 W3C. Content identifiers used in ROs conform to a standard for uniform resource indicators (URIs), namely RFC 2392. To provide the solution and thereby preserve expensive bandwidth for ROs, OMA DRM 2.0 compliant ROs are transformed into a binary format referred in the foregoing as binary rights objects (BROs). Moreover, the solution also involves use of a function to transform a URI-type of identifier into a binary format referred to as binary content identity (BCI). A beneficial way to transform the textual identifier to an equivalent binary one is to use a collision-free hash function as elucidated briefly in the foregoing. Optionally, the output of the hash function is restricted to typically 128 bits for MD5, namely standard RFC 1321, or 160 bits for SHA-1, namely standard FIPS 180.2. The hash function SHA-1 has desirable collision properties and has a further advantage in that it is already specified for use with OMA. Alternatively, for implementing the function, AES, namely FIPS 197 standard, in a CBC-MAC mode with a hash key is beneficial to use. AES is of advantage relative to SHA-1 for use in generating the binary identity in that its output is 4 bytes smaller. Definitions pertaining to the solution are provided in Table 4.

TABLE 4

| Parameter | Definition |
|---|---|
| hash_key | 16-byte random key |
| content_id | Addr-spec |
| cid-url | “cid” “:” content_id |
| Binary_content_id | f(public_hash_key], <cid-url>) wherein f denotes |
| | the aforementioned function |

The RO's<uid> equals the cid-url and the function ƒ implements either SHA-1 or, when the optional hash-key parameter is given, AES in CBC-MAC mode. Thus, the binary_content_id is part of every traffic key (TEK) message and provides thereto bandwidth reduction benefits.

With regard to broadcast ROs for OMA, there are two ways in the OMA DRM 2.0 standard to issue ROs, namely there are uniquely addressed ROs and, alternatively, domain addressed ROs. Unique addressing of ROs over a broadcast channel, for example the channel 320, without a return channel is expensive with regard to required bandwidth and does not scale well. Conversely, OMA domain addressing for ROs is not intended for use in a dynamic environment, wherein larger numbers of receiving devices are joining or leaving a given domain. To maintain scalability and to achieve a high addressing efficiency, the present invention utilizes broadcast rights objects (BCRO) that can be in XML or binary formats.

In the systems 10, 300, 2400, 2700, after registration of receiving devices therein, for example the terminal 500, each receiving device will become a member of a group of m out of a population of n devices. Conveniently, such a group is denoted as being a broadcast group (BG). In operation of the systems 10, 300, 2400, 2700, each receiving device therein will receive several BG-specific keys during a registration process implemented within the systems 300, 2400, 2700. The BG-specific keys provide for confidentiality and authenticity of BCRO messages. An issuer, for example the network 400, optionally can sign BCRO messages using its private key; however, such signing results in at least 1024-bits being added to the BCRO messages on account of the size of RSA signatures employed. Beneficially, message authentication codes such as AES CBC-MAC are supported in such a scenario. Thus, in the systems 10, 300, 2400, 2700, an update for BG-specific keys requires re-registration. Moreover, all RO addressing, using the broadcast channel, is BG-based.

Each receiving device or set of such devices within a BG can be given access to a service encryption key (SEK) encapsulated in a corresponding unique BG rights object. Thus, an m-bit mask included in a main part of the BCRO is optionally used for addressing within a BG. In a situation wherein a particular receiving device is entitled to a specific product, then, according to its position in the BG, a corresponding bit is set in the aforesaid bit mask. The size of the bit mask is susceptible to being optimized depending on the number of authorized receiving devices within the BG. For example, given a BG size of 256 receiving devices and an average entitlement size of 128 bytes, bandwidths required for specifying each product are provided in Table 5.

TABLE 5

| | Number of receiving devices | | | | |
|---|---|---|---|---|---|
| | | 500,000 | 1,000,000 | 2,000,000 | 4,000,000 |
| Cycle | 15 minutes | 2.22 kbits/sec. | 4.44 kbits/sec. | 8.89 kbits/sec. | 17.78 kbits/sec. |
| time | 30 minutes | 1.11 kbits/sec. | 2.22 kbits/sec. | 4.44 kbits/sec. | 8.89 kbits/sec. |
| | 45 minutes | 0.74 kbits/sec. | 1.48 kbits/sec. | 2.96 kbits/sec. | 5.93 kbits/sec. |
| | 1 hour | 0.56 kbits/sec. | 1.11 kbits/sec. | 2.22 kbits/sec. | 4.44 kbits/sec. |

In the systems 10, 300, 2400, 2700, there are two levels of security possible, namely:

(a) receiving device tamper resistant; and

(b) cryptographically secure.

When tamper resistance is implemented, receiving devices, for example the terminal 500, does not use one or more SEKs included in BCROs in a case where its bit is not set in the aforesaid bit mask. Conversely, when the cryptographically secure level is implemented, cryptography is used to secure access to the one or more SEKs in the BRCO for individual devices rather than for all receiving devices forming part of a BG. Cryptographic processes employed are conveniently referred to as “zero message broadcast encryption”, see a publication “Broadcast Encryption in Advances in Cryptography”, Fiat and Naor, Crypto 1993. Disadvantages of employing cryptographically-secure communication in the systems 300, 2400, 2700 are that computation requirements are increased, and that more key storage is required; typically, a requirement for key storage is related to log(m) wherein m is the size of the BG. The log(m) stored keys are used for deriving binary sub-trees, wherein, for each leaf of such trees, a key is calculated if a bit is set in the aforementioned n-bit mask included in the BCRO. Optionally, as elucidated earlier, substantially all calculated keys, namely n−1 keys, are optionally mutually EXOR-ed to obtain an actual decryption key for the BCRO.

In the systems 10, 300, 2400, 2700, traitor tracing is possible when a set of BG keys are illegally distributed therein. For the aforesaid tamper resistant level of security, traitor traceability is limited to individual broadcast domains. However, for the aforesaid cryptographically secure level of security, traitor traceability can be achieved to all individual receiving devices in the BG.

In one implementation of the present invention wherein REL DTD (Rights Expression Language Document Type Definitions) is not changed, the OMA DRM 2.0 standard is employed and uses a URI to reference a RO from a DCF which implements the same URI in the <uid> element of its context model. The format of the URI is defined in the standard RFC 2392, namely cid-url. Since the URI is US-ASCII based, these URI identifiers are inconveniently large in number of bytes to be part of an aforementioned ECM message, the latter being typically less than 184 bytes. An example of an ASCII based URI is:

content_id=addr-spec

cid-url=“cid” “:” content_id

for example: cid:movie123@philips.com

One way to transform such a textual identifier to a binary one is using an aforementioned collision free hash function. The output of the hash function is restricted to typically 128-bits for MD4/MD5 or 160 bits for aforementioned SHA-1. As elucidated earlier, the SHA-1 function is preferred because it is a FIPS standard and exhibits relatively better collision properties and is specified for use within the OMA standard. Alternatively, a function based on AES in CBC-MAC mode can be employed using a public symmetrical key. A benefit of AES over SHA-1 is that it can be implemented in hardware. A pertinent definition is provided in Table 4 in the foregoing. For the rights object the <uid> element equals the cid-url and also the output of the aforesaid function, namely SHA-1 AES in CBC-MAC mode. The binary_content_id will then be part of every aforesaid ECM message.

When implementing such a way of transforming the textual identifier in the systems 300, 2400, 2700, a OMA receiving device, for example the terminal 500, receives an ECM message. From the ECM data is extracted the binary_content_id. The OMA receiving device searches in its internal cache list to find corresponding rights objects (ROs) using the binary_content_id as a search key. If there is a cache “hit”, namely a match is found between the binary_content_id and a rights object, a content encryption key in the found rights object is used to decrypt the ECM message, thereby subsequently enabling access to corresponding encrypted data content. Conversely, if a cache “miss” occurs, namely no match is found between the binary_content_id and a rights object, there is no content encryption key available to decrypt the ECM message, hereby denying access to encrypted data content. In a situation wherein a cache “miss” occurs, the OMA receiving device can optionally search “offline”, for example in databases external thereto, for rights objects (ROs) and then calculate the binary_content_id for the <uid> elements; if a corresponding binary_content_id is found, a corresponding rights object (RO) may be optionally imported to the receiving device and cached therein together with the binary representation of its >uid> element, for example for use in future searches.

In another implementation of the invention wherein REL DTD (Rights Expression Language Document Type Definitions) is changed, there is changed a following element in the OMA DTD 2.0 REL DTD:
<!ELEMENT o-ex:context (o-dd:version?, o-dd:uid*)>
to
<!ELEMENT o-ex:context (o-dd:version?, o-dd:uid*, o-ex:digest*)>

Thus, the hash of the cid-url may be calculated using the function ƒ([public_hash_key],<uid>) as elucidated earlier. Next, the hash algorithm type SHA-1 is applied to the >DigestMethod> and a corresponding hash value to the <DigestValue> element; the <DigestMethod> and <DigestValue> elements are part of the composite element “digest” in the changed element shown immediately above.

Modifications to embodiments of the invention described in the foregoing are possible without departing from the scope of the invention as defined by the accompanying claims.

Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural and vice versa.

Numerals included within parentheses in the accompanying claims are intended to assist understanding of the claims and should not be construed in any way to limit subject matter claimed by these claims.

1. A method of associating data content with rights objects in a communication system, said system comprising a data content transmitter and at least one data receiver, said method comprising steps of:
providing data content, rights objects defining rights to the data content, and control messages for controlling subsequent processing to be applied to the data content, wherein said control messages reference said rights objects;
generating textual identifiers operable to associate said data content with said rights objects;
transforming said textual identifiers into corresponding identification data; and
compiling the identification data, the rights objects and the control messages to generate output data for transmission from the transmitter and subsequent receipt at said at least one data receiver.

2. A method of associating data content as claimed in claim 1, wherein said step of transforming said textual identifiers into said corresponding identification data involves transforming said textual identifiers into said corresponding identification data in binary form, said identification data in binary form being more compact than their corresponding textual identifiers.

3. A method of associating data content as claimed in claim 1, wherein the rights objects are OMA DRM rights objects.

4. A method as claimed in claim 1, further comprising the steps of:
receiving the output data at said at least one data receiver; and
processing the identification data and regenerating an association between the data content and the rights objects for controlling use of the data content at said at least one data receiver.

5. A method as claimed in claim 1, wherein the identification data is incorporated into the control messages when being compiled to generate the output data.

6. A method as claimed in claim 1, wherein the identification data is generated from the textual identifiers using at least one of a hash function and an encryption function.

7. A method as claimed in claim 6, wherein the hash function is substantially implemented by a contemporary Message Digest pursuant to a standard RFC 1320/1321.

8. A method as claimed in claim 6, wherein the hash function is substantially implemented by a SHA-1 Secure Hash Algorithm pursuant to FIPS 180-2.

9. A method as claimed in claim 6, wherein the encryption function is implemented substantially pursuant to an advanced encryption standard FIPS 197 utilizing a public symmetrical key for the transmitter and said at least one data receiver.

10. A method as claimed in claim 1, wherein a plurality of said data receivers is initially registered to the system by
grouping the plurality of data receivers into a broadcast domain;
communicating one or more access keys to the plurality of broadcast receivers in the broadcast domain for defining data content accessible to the broadcast domain, said keys being useable to access encrypted rights objects communicated in the system.

11. A method as claimed in claim 1, wherein the data content is associated by the textual identifiers with its associated rights objects by way of a uniform resource indicator comprising a content identifier linked to a corresponding universal resource locator.

12. A method as claimed in claim 4, wherein regenerating the association between the data content and the rights objects at each data receiver involves deriving from the control messages a content indication for use in searching corresponding rights objects, such that a lack of a match found at the data receiver between the content indication and rights objects stored in the data receiver, or externally accessible to the data receiver, is indicative of the data receiver lacking rights to access the data content.

13. A method of providing conditional access, said method comprising steps of:
Including encrypted data content in a data stream, wherein decryption of said data content requires temporally changing control words;
Including first decryption messages in the data stream, each first decryption control message containing at least one of the control words that is required for decrypting data content that is substantially contemporaneous with the first decryption control message in the data stream;
Extracting a first decryption control message from the stream in a stream receiving device;
Associating an OMA DRM rights object to the first decryption control message extracted;
Obtaining a content encryption key from the OMA DRM rights object associated;
Decrypting the first decryption message extracted using the content encryption key obtained from the OMA DRM rights object;
Extracting a control word from the first decryption message decrypted;
Decrypting the encrypted data content using the control word extracted from the first decrypted message decrypted.

14. A method as claimed in claim 13, wherein the step of associating an OMA DRM rights object to the first decryption message extracted further comprises steps of:
Mapping an address of the OMA DRM rights object to one or more bits;
Including said one or more bits in the first decryption control message;
Extracting said one or more bits from the first decryption control message received;
Comparing said one or more bits extracted with one or more bits of a stored OMA rights object; and
Selecting the stored OMA DRM rights object to be the OMA DRM rights object associated when said one or more bits extracted are equal to one or more bits of the stored OMA DRM rights object.

15. A method as claimed in claim 14, wherein the step of mapping an address of the OMA DRM rights object to one or more bits includes calculating a hash of the address of the OMA DRM rights object.

16. A method as claimed in claim 15, wherein the step of calculating the hash of the address of the OMA DRM rights object further comprises selecting a hash function from a set of hash functions.

17. A method as claimed in 16, wherein the hash function selected is indicated by a bit in the first decryption message.

18. A method as claimed in claim 15, wherein the address is a URI of the OMA DRM rights object.

19. A system for implementing a method as claimed in claim 1 for providing conditional access for a stream receiving device to an encrypted data stream.

20. A stream receiving device for obtaining conditional access to an encrypted data stream, the receiving device being arranged to execute steps of:
Extracting a first decryption control message from the stream in the stream receiving device;
Associating an OMA DRM rights object to the first decryption message extracted;
Obtaining a content encryption from the OMA DRM rights object associated;
Decrypting the first decryption message extracted using the content encryption key obtained from the OMA DRM rights object;
Extracting a control word from the first decryption message decrypted; and
Decrypting the encrypted data content using the control word extracted from the first decryption message decrypted.

21. A computer program product for obtaining conditional access to an encrypted data stream, the computer program product being arranged to, when run on a processor, execute a step of associating an OMA DRM rights object to a first decryption message extracted from the encrypted data stream.

22. (canceled)

23. (canceled)

24. (canceled)
